(19) United States
(12) Patent Application Publication
(10) Pub. No.: US 2009/0090137 A1
(43) Pub. Date: Apr. 9, 2009

(54) WASHING MACHINE AND METHOD FOR UPDATING OPERATIONAL DATA OF A WASHING MACHINE

(76) Inventors: Hoi Jin JEONG, Changwon-si (KR); Phal Jin Lee, Changwon-si (KR); Jong Hye Han, Changwon-si (KR); In Haeng Cho, Changwon-si (KR)

Correspondence Address: KED & ASSOCIATES, LLP, P.O. Box 221200, Chantilly, VA, 20153-1200, US

(21) Appl. No.: 12/248,565

(22) Filed: Oct. 9, 2008

(30) Foreign Application Priority Data
Oct. 9, 2007 (KR) 10-2007-0101603

(51) Int. Cl. D06F 33/02; G06F 12/02

(52) U.S. Cl. 68/12.02; 710/13

(57) ABSTRACT

A washing machine is provided that performs washing using a new washing course employed in the latest washing machine without any change in the mechanical components of the washing machine, by providing a means to update operational data related to the operation of the washing machine. The washing machine may include a controller that controls the washing machine using electric signals, and an internal storage device that stores operational data of the controller. An external device that stores upload operational data, which is distinguished from the operational data may be electrically connected to the controller so that a function of the operational data may be replaced with the upload operational data.

### BACKGROUND

1. Field

A washing machine and a method for updating operational data of a washing machine are disclosed herein.

2. Background

Washing machines are known. However, they suffer from various disadvantages.

### BRIEF DESCRIPTION OF THE DRAWINGS

Embodiments will be described in detail with reference to the following drawings in which like reference numerals refer to like elements, and wherein:

FIG. 1 is a front perspective view of a washing machine in accordance with an embodiment;

FIG. 2 is a cross sectional view taken along line II-II of FIG. 1;

FIG. 3 is a block diagram showing a connected state between the washing machine of FIG. 1 and an external device in accordance with an embodiment;

FIG. 4 is a flow chart of a method of downloading upload operational data from an external device in accordance with an embodiment;

FIG. 5 is a flow chart of a method of operating a washing machine according to upload operational data stored in an external device in accordance with an embodiment;

FIG. 6 is a flow chart of a method in which a washing machine is connected to an external device and receives upload operational data stored in the external device and stores the same in an internal storage device in accordance with an embodiment;

FIG. 7 is a block diagram of a connected state between a washing machine and an external device in accordance with another embodiment;

FIG. 8 is a flow chart of a method in which a washing machine is connected to an external device and receives upload operational data stored in the external device and stores the same in an internal storage device in accordance with an embodiment;

FIG. 9 is a flow chart of a method of operating a washing machine according to upload operational data stored in an external device in accordance with another embodiment;

FIG. 10 is a block diagram of a connected state between a washing machine and an external device having an external controller in accordance with an embodiment;

FIG. 11 is a partial plane view of a process in which upload operational data is transmitted to a display of a washing machine in accordance with an embodiment;

FIG. 12 is a perspective view of a washing machine in accordance with another embodiment;

FIG. 13 is a flow chart of a method of transmitting and storing upload operational data in an internal storage device upon inputting of an upload command into an input device in a washing machine in accordance with an embodiment; and

FIG. 14 is a partial perspective view illustrating a process in which an input device of a washing machine and an external device are coupled to a slot in accordance with an embodiment.

### DETAILED DESCRIPTION

In general, a washing machine is an appliance for removing contaminants from clothing, beddings, and similar items (hereinafter, referred to as “laundry”) by using a chemical decomposition of water and detergent and a physical action, such as friction, between water and laundry. Washing machines may be divided into different types, such as a water-jet washing machine that washes laundry by friction between water and laundry or between laundry, which is caused by forming turbulence in the wash water in a washing tub, and a drum type washing machine that washes laundry by a physical impact generated by rotation of a drum when laundry put into the drum is lifted by a lifter formed in the drum and then dropped.

Washing machines perform a washing process by combining various strokes, including, for example, a washing stroke to remove contaminants from the laundry, a rinsing stroke to remove detergent from the laundry, a dehydration stroke to dehydrate the laundry, a drying stroke to dry the laundry, and a steam spraying stroke to spray steam onto laundry. By combining these strokes, washing performance may be improved, and various indexes related to the performance of a washing machine may be improved, including reduction of electric power consumption. Therefore, manufacturers of washing machines enhance performance of washing machines by combining these strokes. Further, the manufacturers suggest new strokes by selecting and combining these strokes, thereby improving product competitiveness.

However, if the operation of a washing machine is changed by combining such various strokes, there may be no significant change in the mechanical components of the washing machine, but rather, in most cases, only various operational data stored in an internal storage device of the washing machine is changed. This is because changing the components of the washing machine has various physical and electronic limitations, while it is relatively easy to enhance performance of the washing machine by changing operational data. However, changing the operational data requires changing data in a microcomputer inside of the washing machine, and hence, this should be done directly by the manufacturer of the washing machine upon manufacture of the washing machine. Because of this, consumers have no choice but to purchase the product again in order to avail themselves of the operations of a new washing machine, such as washing courses, employed in the latest washing machine. This puts a big burden on consumers.

Consequently, a means for upgrading a washing machine in accordance with the latest products would have a great appeal to consumers. However, no such idea has previously existed in the field of the technology of washing machines.

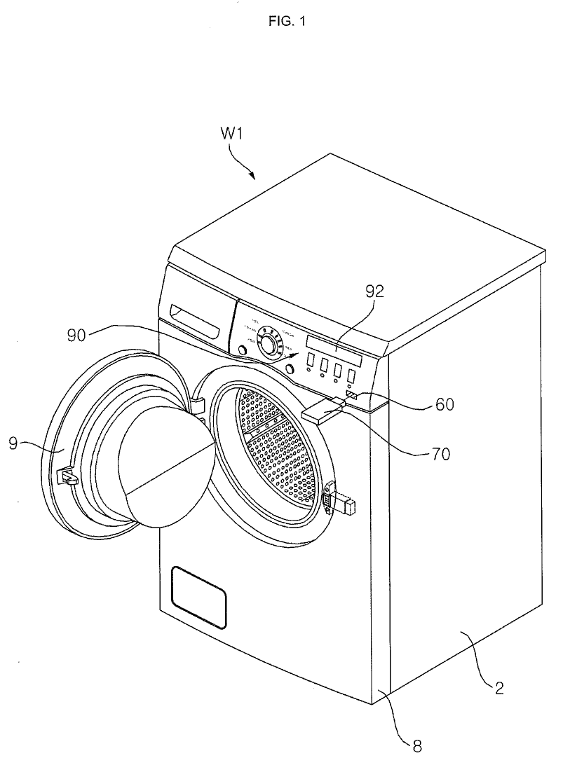

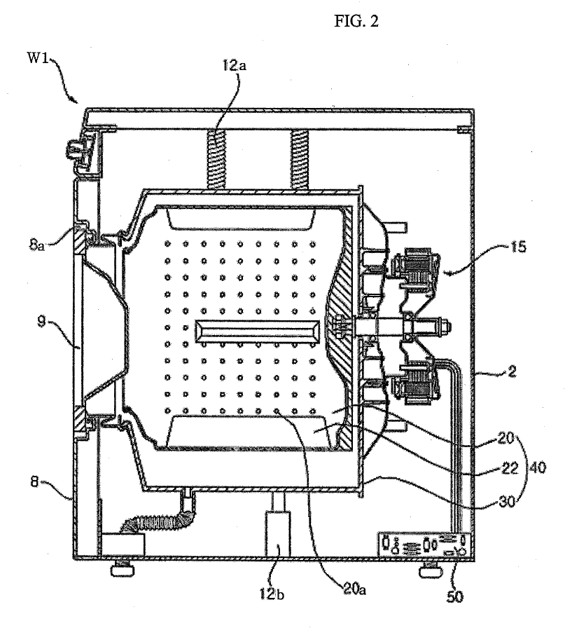

Hereinafter, a washing machine W1 according to an embodiment will be described with reference to FIGS. 1 to 5. Hereinafter, a general view of the washing machine W1 according to an embodiment will be described with reference to FIGS. 1 and 2. Although FIGS. 1 and 2 illustrate an external device being connected to a drum type washing machine, the washing machine of this embodiment is not necessarily restricted to a drum type washing machine, but may also be applicable to a water-jet washing machine or other washing machines that wash laundry using a driving force, such as a rotation force. Therefore, embodiments are not limited to the type of washing machine disclosed herein.

The washing machine W1 may include a cabinet 2 forming an outer appearance of the washing machine W1, a washing tub 40 installed in the cabinet 2 and containing washing water therein to wash laundry, a driving source 15 mounted at a rear of the washing tub 40 and providing a driving force to be transmitted to the washing tub 40, a controller 50 that controls the driving source 15 and other devices by using electric signals, an internal storage device 55 that stores operational data, which is various information related to the operation of the washing machine, and constituting one component of the controller 50, a cabinet cover 8 mounted on a front surface of the cabinet 2 and constituting the cabinet along with a door section 8a formed at a center thereof, a door 9 rotatably installed on the cabinet cover 8 so as to open and close the door section 8a of the cabinet cover 8, a display 90 that displays information about the operation of the washing machine W1, and a slot 60 into which an external device 70 that stores upload operational data may be mounted. The term “upload operational data” hereinafter refers to operational data to be downloaded from an external source or uploaded to the washing machine.

In FIG. 1, the slot 60 is shown formed at an upper portion of the front cabinet 8. However, the slot 60 may be provided anywhere, including at a side portion of the cabinet 2 and a lower portion of the front cabinet 8. Further, the external device 70 may include any storage devices capable of storing and transmitting data, including a flash memory type storage device, such as an USB memory device or a SD memory, a magnetic storage device, such as a diskette, and an optical storage device, such as an optical disk. A display apparatus 92 provided on the display 90 is not limited to a specific one, but may be one of various display apparatuses, such as an LCD, an OLED, and a PDP, or a sounding apparatus.

The washing tub 40 may include a tub 30 installed in the cabinet 2 so as to be damped by springs 12a and a damper 12b and containing wash water, a drum 20 rotatably installed in the tub 30 and configured to hold laundry and be rotatably driven by the driving source 15 and having a plurality of through holes 20a through which wash water passes, and a lifter 22 installed on an inner surface of the drum 20 so that laundry may be lifted to a predetermined height and then dropped by gravity during rotation of the drum 20.

The controller 50 may include an IC chip and electronic devices, and may control the overall operation of the washing machine W1, including controlling operation of the driving source 15, a number of rotations, a rotation time in accordance with operational data, and determining the operation thereof by applying electric signals to other various devices, such as a water supply valve (not shown), a drain valve (not shown), and a steam generator (not shown). Further, the controller 50 may be a microcomputer. The type or capacity of the controller 50 may be variously changed with the development of technology, and thus, the scope of embodiments is not dependent upon the type of the controller 50, and the controller 50 may be replaced by various other types as technology develops.

Meanwhile, the internal storage device 55 may be a RAM, but is not limited thereto and may be replaced with various other types of storage devices, such as a magnetic disk device, an optical disk device, and a flash memory type storage device. Accordingly, the type of the internal storage device 55 may also be replaced by various types as technology develops.

Although the internal storage device 55 has been described as one component of the controller 50, the internal storage device 55 is not necessarily restricted thereto and may be manufactured as a separate module type. Thus, the internal storage device 55 may be a separate component.

Since the washing tub 40 has been described with respect to a drum type washing machine, its description is only provided for a case in which a structure provided with a drum and a tub is required. However, the washing tub according to embodiments is not limited to the above description; rather, other type of washing machines, for example, a water-jet washing machine, may be employed, including a water tank that stores water and a fan that forms turbulence in the water tank. Additionally, the door section 8a is not necessarily formed on the front surface and is not limited thereto, but may be formed on, for example, an upper surface.

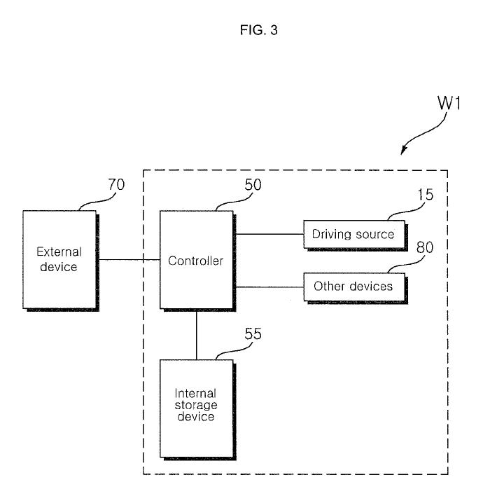

Hereinafter, a connection relationship between an external device and the controller 50 will be discussed with reference to FIG. 3. The controller 50 may be electrically connected to the driving source 15 and other devices 80. A controlling method of the driving source 15 and other devices 80 by the controller 50 will be described below by way of example. When laundry is put into the washing machine W1 and a washing course is carried out, the controller 50 may open the water supply valve, which is one of the other devices 80, to introduce wash water into the washing tub 40, and adjust an opening time of the waster supply valve in accordance with an amount of wash water sensed by a mass sensor (not shown) in the washing tub 40. Afterwards, the driving source 15 may be rotated a predetermined number of rotations to perform a washing stroke. Thereafter, the drain valve may be opened to drain the wash water and introduce new wash water into the washing tub 40. Then, the driving source 15 may be rotated again a predetermined number of rotations to perform a rinsing stroke. These strokes may be repeated according to pre-optimized operational data, the wash water may be drained out, and then the driving source 15 may be rotated a high number of rotations to perform a dehydration stroke. In these respective steps, the controller 50 may apply electric signals to the driving source 15, the water supply valve, and the drain valve to control their operations. In accordance with the type of washing machine, information regarding these respective steps may be displayed on the display 90 to provide the information to a user. Such operation of the washing machine W1 may be implemented by the controller 50 by detecting the operational data stored in the internal storage device 55 and controlling the driving source 15 and other devices 80 in accordance with the operational data. Therefore, if the operational data stored in the internal storage device 55 is changed, the washing machine W1 may perform other operations.

However, such operational data is employed after many tests and safety checks are performed in the manufacturer's workshop, and hence, it takes considerable time to develop the operational data. Further, the operational data may be varied by a change in components. For example, if the driving source of the washing machine is changed or a new device is attached, the operational data may be changed and developed according to various objectives, such as washing performance and the improvement of power consumption efficiency, due to the structural limits of the washing machine, rather than by a change in the components of the washing machine. Therefore, even if a novel washing machine is released, it is often the case that no change is made in the components between an old model washing machine and the latest washing machine. Rather, enhancement of washing performance is achieved only by the introduction of a washing stroke based on a new concept or by the modification of operational data for an existing washing stroke. In this case, the old model washing machine may be used just like the latest washing machine by only upgrading the operational data of the old model washing machine. Accordingly, if the operational data stored in the controller 50 of the washing machine W1 is improved, the operational data may be replaced with new operational data, (hereafter referred to as “upload operational data” for convenience sake), thereby enhancing the performance of the existing washing machine. In order to accomplish this, the external device 70 as shown in FIG. 1, which stores the upload operational data to replace the existing operational data may be electrically connected to the controller 50, for example, by being mounted in the slot 60 of the washing machine W1. It should be noted that electrical connection of the external device 70 to the controller 50 is not limited to a configuration in which the external device 70 is inserted into the slot 60, as shown in FIG. 1. Rather, the external device 70 and the controller 50 may be electrically connected by other well known means as well, including connection to a USB port, connection via a cable, and connection using a wireless LAN.

Meanwhile, the controller 50 may detect stored existing operational data and replace it with upload operational data. Further, there may occur a case in which the controller 50 is unable to replace the existing operational data with the upload operational data. If the existing operational data is not replaced with the uploaded operational data, the washing machine W1 may malfunction. Due to this malfunction, laundry may be damaged. Therefore, in a case in which the stored operational data is to be detected and replaced with the upload operational data, the controller 50 determines whether the operational data may be replaced with the uploaded operational data. If the controller 50 determines that the replacement of the stored operational data with the upload operational data is not possible or has failed, it stops the replacement by the upload operational data. After stopping the replacement by the upload operational data, the operational data is restored to prevent malfunction of the washing machine W1. On the other hand, if the controller 50 determines that the operational data may be replaced with the upload operational data, it replaces the operational data with the upload operational data to drive the washing machine W1. Thus, if the upload operational data is lost due to an external influence or the replacement by the upload operational data fails, the controller 50 may restore the operational data to operate the washing machine W1. Accordingly, even if the operational data is not replaced with the upload operational data due to, for example, a user's mistake, the user may stably operate the washing machine W1.

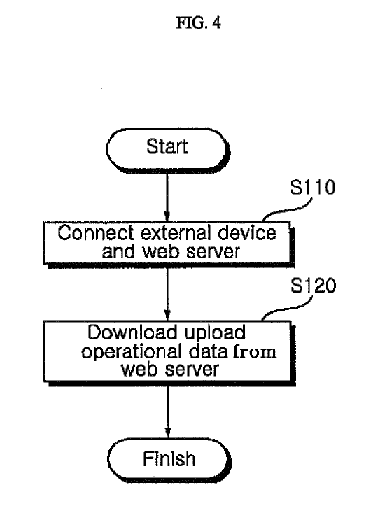

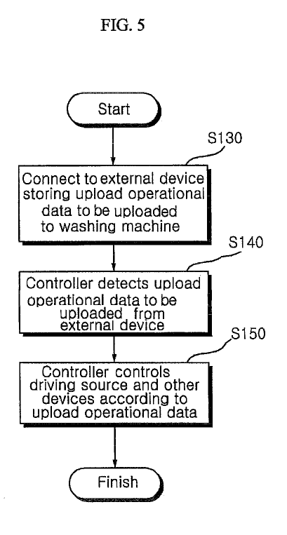

Hereinafter, referring to FIGS. 4 and 5, a method for storing upload operational data in an external device according to an embodiment and how the washing machine operates in accordance with the upload operational data stored in the external device will be described. First, referring to FIG. 4, the method for storing upload operational data in an external device according to an embodiment will be described. Upload operational data may be, for example, pre-stored on a web server of a manufacturer of a washing machine or a company in charge of management of uploaded operational data. A user may connect external device 70 to a computer to access the web server, in step S110. Then, the new operational data may be downloaded from the web server and stored in the external device 70 using the computer, in step S120.

FIG. 4 is merely an illustration of one example of downloading new operational data from a computer by using a portable storage medium, such as an USB memory or a SD memory. According to the policy of the manufacturer of the washing machine, the manufacturer may, for example, store operational data in the form of a memory chip in advance in an external device so that a user wanting to upgrade the washing machine may purchase the external device storing the upload operational data, or an after-sales service staff may upgrade the washing machine by performing the above operation in advance. Therefore, as shown in FIG. 4, it may not be necessary to carry out the method of storing upload operational data in the external device.

Referring to FIG. 5, in this embodiment, the method of replacing operational data with upload operational data will be described. The external device 70 storing upload operational data may be coupled to the washing machine W1, and thus, electrically connected to the controller 50, in step S130. Then, when the external device 70 is connected, an electric signal related to the connection may be transmitted to the controller 50. The controller 50 having received the electric signal may access the external device 70, rather than the internal storage device 55, to detect the upload operational data from the external device 70, in step S140. Then, the driving source 15 and other devices 80 may be controlled according to the detected upload operational data, thereby carrying out the entire course of the washing machine.

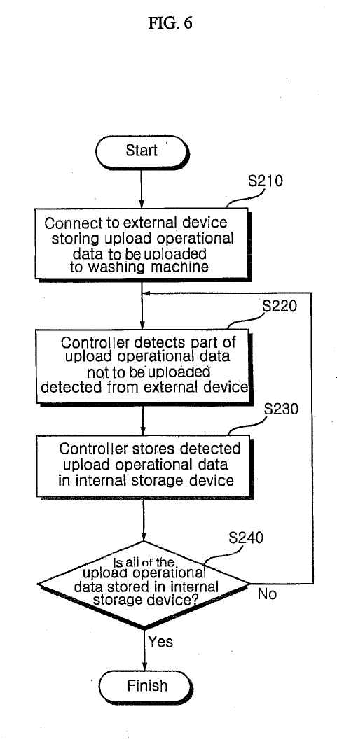

Hereinafter, another embodiment will be described with reference to FIG. 6. The components and operation of the washing machine according to this embodiment may be identical to those of the embodiment of FIGS. 1-5, except that upload operational data stored in an external device may be stored in an internal storage device to operate the washing machine. Thus, description overlapping with the washing machine W1 in accordance with the embodiment of FIGS. 1-5 will be omitted.

The external device employed in the embodiment of FIG. 6 may have no differences from that of the embodiment of FIGS. 1-5, and upload operational data may be stored in the external device in the same manner as illustrated in the embodiment of FIGS. 1-5. Further, in the case that the operational data is replaced with the uploaded operational data, if the upload fails, controlling is done as illustrated in the embodiment of FIGS. 1-5. However, unlike the embodiment of FIGS. 1-5 in which the controller 50 reads upload operational data stored in the external device 70 to operate the washing machine, the uploaded operational data stored in the external device 70 is stored in an internal storage device, and the operation of the washing machine is carried out by using the stored operational data. While the washing machine W1 according to the embodiment of FIGS. 1-5 has the possibility that the external device 70 and the controller 50 may disconnected during the operation of the washing machine, thus stopping the operation of the washing machine or causing problems because the external device is attachable to and detachable from the washing machine, the washing machine of this embodiment may avoid these problems in advance.

Hereinafter, the process of storing upload operational data stored in the external device 70 in the internal storage device 55 in the washing machine according to the embodiment of FIG. 6 will be described.

First, the external device 70 storing upload operational data may be connected to the washing machine, in step S210. The connecting method may not be the same as that of the embodiment of FIGS. 1-5. When the external device 70 is connected to the washing machine, the controller 50 may detect part of the upload operational data stored on the external device 70, in step S220. Afterwards, the detected part of the upload operational data may be stored in the internal storage device 55, in step S230. Then, the controller 50 may check whether all of the upload operational data stored on the external device 70 has been detected and stored in the internal storage device 55, in step S240. Step S240 may be carried out by checking the address at which the upload operational data detected from the external device 70 is stored, or by checking if a data value on the memory in which the detected upload operational data in the external device 70 exists is a null value showing that it is the final value of the data. When it is determined that the storage of the upload operational data is not finished, in step S240, the controller 50 may repeat steps S220 and S230, until all of the upload operational data is stored in the internal storage device 55. When the controller confirms that all of the upload operational data is stored in the internal storage device, this routine is finished. On the other hand, in a case in which the operational data is replaced with the upload operational data, if this fails, controlling is done as illustrated in the embodiment of FIGS. 1-5.

The upload operational data may be written over an address of the memory storing the operational data of the internal storage device or may be stored in a separate memory space. If there is enough room in the memory space, the latter option may be desirable because the user may want to restore the washing machine to the previous operational data. However, the choice is a policy choice between the increase in costs resulting from an increase in storage space and the preference of the consumers.

While this embodiment has been described with respect to a case in which the controller detects part of upload operational data from the external device and stores it in the internal storage device, embodiments are not limited to this method. In general, the controller may store detected data in the memory allocated in conjunction with the transmission of data in the process that the controller transmits upload operational data, and the controller detects and transmits it to the internal storage device. Further, if there is enough room in the memory, it may also be possible for the controller to store upload operational data in a manner such that it detects the entire upload operational data and then stores it in the internal storage device. If the transmission speed between the controller and the memory is higher than the transmission speed between the controller and the internal storage device, this method has an advantage in terms of transmission speed. However, if there is no difference in transmission speed, it may also be possible for the controller to store upload operational data in a manner so as to store the upload operational data directly into the internal storage device without the process of storing the detected upload operational data in the memory allocated to the controller. Thus, whether the controller detects part or all of upload operational data does not restrict the scope of the embodiments disclosed herein. Further, although the embodiments disclosed herein have been described with respect to a case in which the controller 50 undergoes the step S240 of checking whether all the upload operational data is transmitted, the step S240 may not be required if the controller 50 detects upload operational data while storing the address of the memory at which each of the upload operational data is stored in the process of detecting the upload operational data.

When upload operational data is stored in the internal storage device 55 as described above, the controller 50 may read the upload operational data stored in the internal storage device 55 upon operation of the washing machine, and carry out operations according to this data, thereby allowing the user to use an updated washing course of the washing machine.

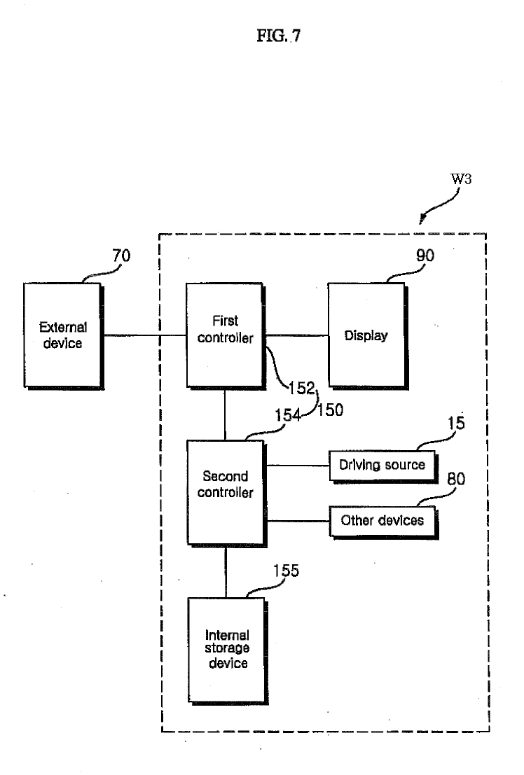

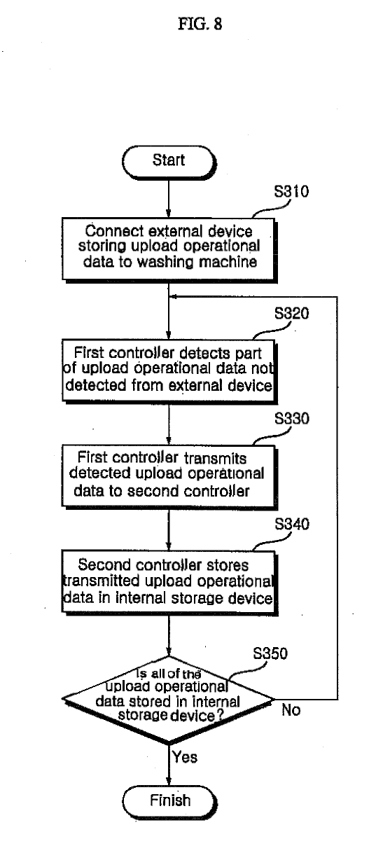

Hereinafter, a washing machine in accordance with another embodiment will be described with reference to FIGS. 7 to 9. The components and operation of the washing machine according to this embodiment may be identical to those of the embodiment of FIGS. 1-5, except that the upload operational data stored in an external device using two controllers may be stored in an internal storage device to operate the washing machine. Thus, descriptions overlapping with the washing machine W1 in accordance with the embodiment of FIGS. 1-5 will be omitted.

The washing machine W3 of this embodiment may include a controller 150 comprising a first controller 152 and a second controller 154. The first controller 152 may control various display apparatus 92 provided in a display 90, and the second controller 154 may control a driving source 15 and any other devices 80 not including the devices provided in the display 90. The first controller 152, which may be a separate controller, may be provided in addition to the second controller 154, because a controller used in a washing machine in most cases generally comprises an IC chip having a low processing capacity and low speed due to cost. Therefore, several controllers may be provided, to control the display 90 and the driving source 15, in consideration of the processing capacity of the IC chip used in the washing machine. Further, in this embodiment the number of controllers is two. However, this is merely a result of consideration of the capacity of the controllers and the data to be processed, and the embodiments disclosed herein may be realized by providing two or more controllers or only one controller based on the particular application and the particular controller employed. Thus, the number of controllers does not limit the scope of embodiments.

If the external device 70 is a “pure” storage device provided with no particular controller, there may be a need to appropriately define a separate role for the controller related to data transmission and storage in consideration of the respective capacity of the controller of the washing machine, in order to transmit and store the upload operational data stored in the external device to the washing machine. How upload operational data is stored in the washing machine W3 of this embodiment as will be described with reference to FIG. 7.

The external device 70 storing upload operational data may be coupled and connected to the slot 60 of the washing machine, in step S310. When the external device 70 is connected to the washing machine, the external device 70 may be electrically connected to the first controller 152. Afterwards, the first controller 152 may detect at least part (it is also possible to detect and transmit all of the upload operational data like in the embodiment of FIGS. 1-5) from the external device 70, in step S320. Then, the first controller 152 may transmit the detected upload operational data to the second controller 154, in step S330. Thereafter, the second controller 154 may store the transmitted upload operational data in the internal storage device 155, in step S340. Afterwards, the first controller may check if all of the upload operational data is stored in the internal storage device 155 by, for example, checking the address of the memory detected from the external device, in step S350. However, it may not be necessary that the first controller 152 perform step S350, and step S350 may be performed by the second controller 154. If there is any remaining upload operational data to be transmitted as a result of step S350, steps S320, S330, and S340 of detecting undetected upload operational data and storing it in the internal storage device 155 may be repetitively performed until all of the upload operational data is stored in the internal storage device 155. In a case that the operational data is replaced with the upload operational data, if this fails, controlling may be performed as illustrated in the embodiment of FIGS. 1-5.

In the washing machine of this embodiment, the load of the controller applied in the transmitting of upload operational data to the washing machine from the external device and the load of the controller generated in the storing of upload operational data in the internal storage device may be separated into the first and second controller, and thus, there may be no need to employ a storage device having a large capacity or processing speed in order to update the washing machine. Therefore, the costs related to the components of the washing machine may be reduced.

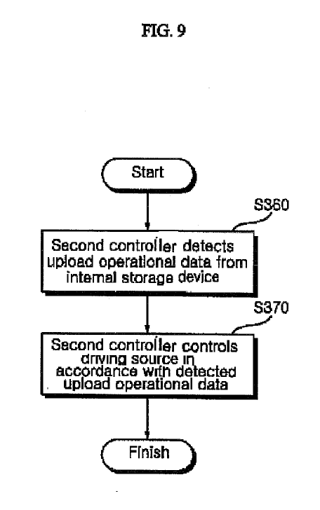

Hereinafter, the driving of the washing machine according to the upload operational data with respect to this embodiment will be described with reference to FIG. 9. After the upload operational data stored in the external device 70 is all transmitted and stored in the internal storage device 155, when the washing machine is operated, the second controller 154 may detect upload operational data from the internal storage device 155, in step S360. Then, various updated washing courses may be performed by controlling the driving source 15 and other devices 80 in accordance with the detected upload operational data.

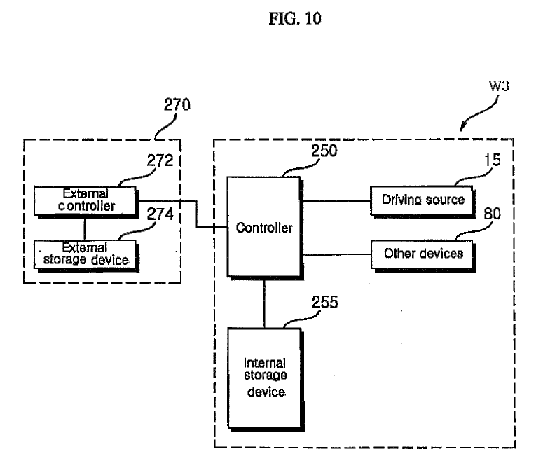

Hereinafter, a washing machine in accordance with another embodiment will be described with reference to FIG. 10. The components and operation of the washing machine according to this embodiment may be identical to those of the previously described embodiment, except that the first controller that performs the process of detecting and transmitting upload operational data stored in the external device may be replaced with an external controller provided in the external device. Thus, descriptions overlapping with the washing machine in accordance with the previously described embodiment will be omitted.

In this embodiment, an external device 270 electrically connected to the controller 250 may include an external controller 272 and an external storage device 274. The external controller 272 may comprise an IC chip to perform the function of controlling via electric signals, and the external storage device 274 may comprise a storage device capable of storing upload operational data, such as a flash memory, an optical disk, or a magnetic disk.

In this embodiment, when the external device 270 is electrically connected to the controller 250, the external controller 272 may detect at least part of upload operational data from the external storage device 274, and transmit the detected upload operational data to the controller 250. The controller 250 may transmit and store the transmitted upload operational data in the internal storage device 254. All of the upload operational data may be stored in the internal storage device 254 by repeating this process until all of the upload operational data is stored. In the case that the operational data to be replaced with the upload operational data, if this operation fails, controlling may be performed as illustrated in the embodiment of FIGS. 1-5.

Afterwards, when the upload operational data is stored in the internal storage device 254, the stored upload operational data may be detected by the controller 250, and the controller 250 may control the driving source 15 or other devices 80. In the case where the external device 270 includes an external controller 272, the cost of the external device 270 increases, thus making it rather difficult to make the external device 270 commercially available in a module. However, sometimes updates cannot be easily done because of the small capacity of the IC chip of the controller provided in the washing machine. Hence, to solve this problem, this embodiment allows the external device 270 provided with a controller 272 to perform updating.

As the external device 270 provided with the external controller 272, electronic devices driven by a battery, such as a PDA, laptop, or mobile phone, may be used in various ways. However, sometimes an apparatus for adjusting a voltage when connecting to the washing machine may be additionally required because the driving voltage of the washing machine and the driving voltage of the computer may be different from each other. This problem may be easily overcome by installing a transformer in the slot 60. Further, the above electronic devices may not share a grounding section with the washing machine because they may be driven by a battery. In this case, problems occurring due to a voltage difference between the external device and the washing machine may be solved.

In the case of connecting a computer connected to a national electric power network, rather than to a battery, to the washing machine in order to perform update of the washing machine, there may occur a problem due to voltage differences between the computer and the washing machine. This also may be overcome by an additional apparatus, such as a transformer.

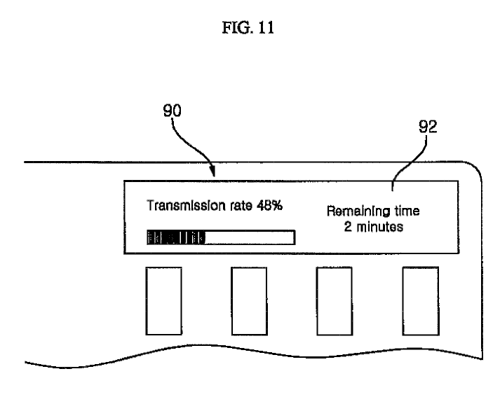

Hereinafter, a washing machine in accordance with another embodiment will be described with reference to FIG. 11. The components and operation of the washing machine according to this embodiment may be identical to those of the embodiments of FIGS. 1-5 except that the process of transmitting and storing upload operational data in the washing machine may be displayed on a display. Thus, descriptions overlapping with the washing machine W1 in accordance with the embodiment of FIGS. 1-5 will be omitted.

When an external device is coupled to the washing machine and upload operational data is transmitted and stored to the washing machine from the external device, at least one of the ratio at which the upload operational data is stored and the remaining time may be displayed on a display apparatus 92 of the display 90.

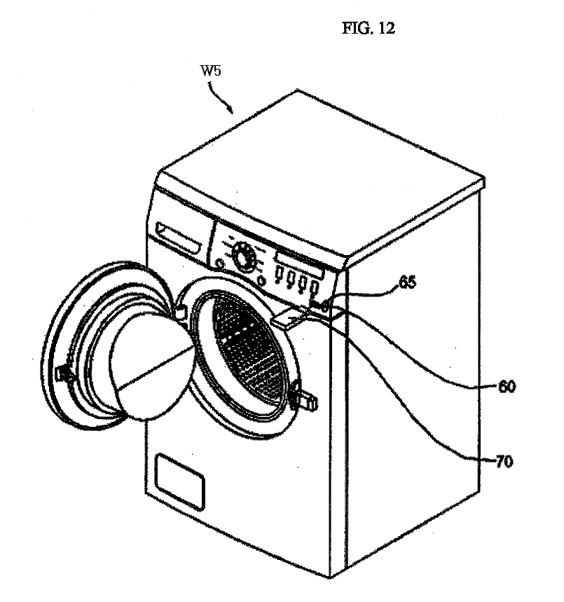

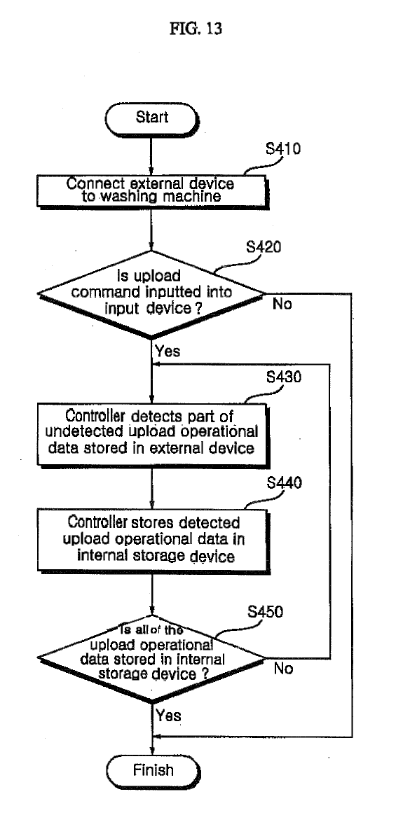

Hereinafter, a washing machine in accordance with another embodiment will be described with reference to FIGS. 12 and 13. The components and operation of the washing machine according to this embodiment may be identical to those of the embodiment of FIGS. 1-5 except that the washing machine may include an input device that may determine a point of time for transmitting upload operational data to the washing machine and storing the same. Thus, descriptions overlapping with the washing machine W1 in accordance with the embodiment of FIGS. 1-5 will be omitted.

The washing machine W5 of this embodiment may include an input device 65 that may determine a point of time for transmitting upload operational data to the washing machine W5 from an external device 70. As shown in FIG. 12, the input device 65 may be a button type or various other type input devices produced with the development of technology, such as a touch screen and a voice recognizer. When an upload command (in FIG. 12, the operation of, for example, pressing an input button of the input device 65) is input into the input device 65, an electric signal may be applied to the controller 50 to start the transmission of upload operational data.

Hereinafter, how upload operational data is transmitted to the washing machine upon inputting of an upload command by the input device will be described with reference to FIG. 13. First, the external device 70 may be connected to the washing machine W5, in step S410. Afterwards, the controller 50 may check if an upload command is input into the input device, in step S420. Since an electric signal may be transmitted to the controller 50 from the input device 65 when an upload command is input into the input device 65, this step may be easily carried out by the controller 50 by sensing the presence or not of an electric signal. Afterwards, when the controller 50 confirms the inputting of an upload command, the controller 50 may detect at least part of the upload operational data stored in the external device 70, in step S430. Thereafter, the controller 50 may transmit and store the detected part of the upload operational data in the internal storage device 55. Afterwards, the controller 50 may check if all of the upload operational data has been transmitted, in step S450. If all of the upload operational data has not been transmitted, the controller 50 may repetitively perform the operation of detecting upload operational data from the external device 70 and transmitting the same, thus storing all of the upload operational data in the internal storage device. In the case that the operational data is to be replaced with the upload operational data, if this operation fails, controlling is done as illustrated in the embodiment of FIGS. 1-5.

In this embodiment, an input device is used to determine the point of time for transmitting upload operational data from the external device to the washing machine, because if the transmission of the upload operational data is stopped due to imprecise coupling of the external device, operational data of the washing machine may be damaged and upload operational data for replacing the operational data may not be completely transmitted. This may make the washing machine inoperable. Accordingly, to solve this problem, the input device that determines the transmission or not of upload operational data after the precise coupling of the external device may be employed.

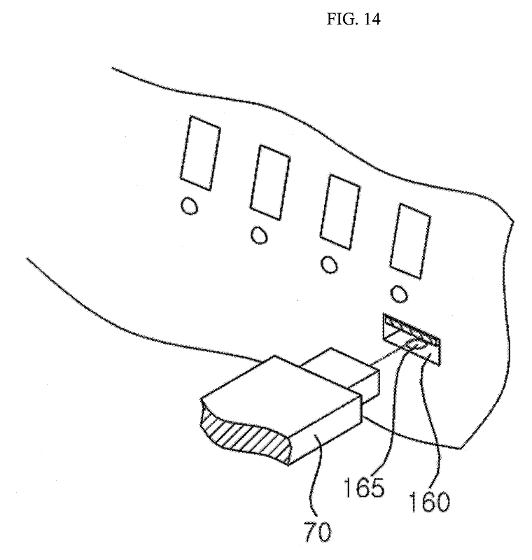

Hereinafter, a washing machine in accordance with another embodiment will be described with reference to FIG. 14. The components and operation of the washing machine according to this embodiment may be identical to those of the embodiment of FIGS. 12-13, except that an input device that determines the point of time for transmitting upload operational data to the washing machine and storing the same may provide in the slot in the washing machine. Thus, descriptions overlapping with the washing machine in accordance with the embodiment of FIGS. 12-13 will be omitted.

As described above, an input device 165 of this embodiment may be provided in a slot 160, and may be in the form of a button provided in the slot 160. When the external device 70 is precisely coupled to the slot, an upload command may be input by the input device 165 as the input device 65 is pressed by insertion of the external device 170 into the slot 160. Thus, a switch may be turned on by the pressure on the input device 165, and accordingly, an electric signal applied to the controller 50 and upload operational data transmitted from the external device 70. In the case that the operational data is to be replaced with the upload operational data, if this operation fails, controlling may be done as illustrated in the embodiment of FIGS. 1-5.

In this embodiment, there is no need to input an upload command through the input device. Rather, an upload command may be input only by coupling the external device 70 to the slot 160, thus reducing the inconvenience of having to input an upload command. Besides, it is possible to design in a way that the point of time for inputting an upload command into the input device may be determined upon precise coupling of the external device only by properly adjusting the position of the input device 165, thereby solving the problems associated with the embodiment of FIGS. 12-13.

Embodiments disclosed herein provide at least the following advantages.

Embodiments disclosed herein provide a means for updating existing operational data of a washing machine.

According to embodiments disclosed herein, there is provided a washing machine including a control unit or controller that controls electric signals, and an internal storage means or device that stores operational data of the control unit, wherein an external device storing upload operational data, which is distinguished from the operational data, is electrically connected to the control unit so that the function of the operational data can be replaced with the upload operational data. In the washing machine, the function of the operational data may be replaced with the upload operational data while the external device is electrically connected to the control unit. Further, the control unit may detect at least part of the upload data stored in the external device to control an electric signal in accordance with the detected upload operational data, thereby achieving the same effect as the updating of operational data to upload operational data. At this time, it may not be necessary for the control unit to detect part of the upload operational data to perform an operation, but it may also be possible for the control unit to detect all of the upload operational data and then perform the operation of the washing machine in accordance with the detected upload operational data.

The washing machine may perform an operation in accordance with upload operational data as follows. That is, the control unit may detect at least part of the upload operational data from the external device to store the detected upload operational data in the internal storage means, and the control unit may detect at least part of the upload operational data stored in the internal storage means to control an electric signal. At this time, as described above, it may also be possible for the control unit to store all the upload operational data in the internal storage means, and then perform an operation in accordance with the upload operational data.

The external device used in the washing machine may be a storage means. Further, the control unit provided in the washing machine may be divided into a first control unit or controller and a second control unit or controller. The first control unit may be electrically connected to the external device and may detect at least part of the upload operational data stored in the external device and transmit the at least part of the upload operational data detected to the control unit. The second control unit may store the upload operational data transmitted from the first control unit in the internal storage means. By this method, the operational data may be replaced with the upload operational data. If the washing machine is provided with a display means or apparatus that displays information related to the operation of the washing machine and a driving source that drives the washing machine, the first control unit may control the display means and the second control unit may control the driving source.

The external device connected to the washing machine may include an external storage means or device that stores the above data, and an external control unit or controller that extracts upload operational data from the external storage means or storing upload operational data in the external storage means. The external device may have a grounding section independent from the washing machine. The external control unit may be electrically connected to the control unit, and the external control unit may perform the function of transmitting at least part of the upload operational data to the control unit. The control unit may perform the function of storing the upload operational data transmitted from the external control unit in the internal storage means. The internal storage means provided in the washing machine may be provided independently, or may be provided in the control unit to physically constitute part of the control unit.

The washing machine may further include a display means or device that displays information related to the operation of the washing machine. At this time, the process of replacing the function of the operational data with the upload operational data may be displayed on the display means.

In the washing machine further including the display means, the upload operational data may be stored in the internal storage means to replace the function of the operational data, and the process of storing the upload operational data may be displayed on the display means. Further, the display means may be a display device, and the display device may display at least one of the ratio at which the upload operational data is stored and the time taken to store all the upload operational data.

The washing machine may further comprise an input means or device. When an upload command is input from the input means, an electric signal may be applied to the control unit so that the function of the operational data may be replaced with the upload operational data.

In the washing machine further including an input means, when a predetermined command is input by the input means while the external device is being electrically connected to the control unit, the control unit may detect at least part of the upload operational data from the external device and control an electric signal in accordance with the detected upload operational data, so that the washing machine may be driven in accordance with the upload operational data.

In the washing machine further including an input means, when an upload command is input into the input means, the control unit may perform the function of detecting at least part of the upload operational data from the external device and storing the detected upload operational data in the internal storage means.

In a case in which the control unit further comprises a first control unit and a second control unit, when an upload command is input into the input means, an electric signal may be applied to the control unit, and hence the first control unit may perform the function of transmitting at least part of upload operational data and the second control unit may perform the function of storing the upload operational data in the internal storage means. The upload operational data to be utilized may be the one that is transmitted to the external device from an external web server storing upload operational data.

Additionally, according to embodiments disclosed herein an external device is provided, which is coupled to a washing machine having a control unit and an internal storage means storing operational data of the control unit and electrically connected to the control unit, and stores upload operational data, the upload operational data being distinguished from the operational data and for replacing the function of the operational data.

With the embodiments disclosed herein the performance of a washing machine may be improved by upgrading operational data of an old model washing machine. Further, the same washing machine as the latest washing machine may be realized without changing the existing washing machine. Accordingly, consumers' loyalty to the product may be increased. Furthermore, new demand may be created by selling an external device for the update of a washing machine or selling upload operational data.

Additionally, the same effect as the purchase of a new model washing machine can be attained by upgrading only operational data while maintaining the existing washing machine, thereby increasing the actual lifespan of the washing machine. Also, the problems that may occur due to the stopping of updating by mistake may be prevented in an early stage by displaying an operational data updating procedure through a display means, and correct information about the time taken for uploading can be delivered to the user.

Sixth, the problems that may occur in the updating procedure can be prevented in an early stage by making clear the point of time of updating of operational data.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A washing machine, comprising:
a controller that controls the washing machine using electric signals; and
an internal storage device that stores operational data of the controller, wherein an external device that stores upload operational data, which is distinguished from the operational data, is configured to communicate with the controller to replace the operational data with the upload operational data.

2. The washing machine of claim 1, wherein the external device is configured to be electrically connected to the controller.

3. The washing machine of claim 2, wherein the operational data is replaced with the upload operational data while the external device is electrically connected to the controller.

4. The washing machine of claim 3, wherein the controller detects at least part of the upload data stored in the external device and controls the electric signals in accordance with the detected upload operational data.

5. The washing machine of claim 1, wherein the controller detects at least part of the upload operational data from the external device and stores the detected upload operation data in the internal storage device, and the controller detects at least part of the upload operational data stored in the internal storage device and controls the electric signals in accordance with the detected stored upload operational data.

6. The washing machine of claim 1, wherein the external device comprises a storage device.

7. The washing machine of claim 6, wherein the storage device comprises one of a flash memory type storage device, a magnetic storage device, or an optical storage device.

8. The washing machine of claim 2, wherein the controller comprises a first controller and a second controller, and wherein the first controller is electrically connected to the external device and detects at least part of the upload operational data stored in the external device and transmits the detected at least part of the upload operational data to the second controller.

9. The washing machine of claim 8, wherein the second controller stores the upload operational data transmitted from the first controller in the internal storage device.

10. The washing machine of claim 8, further comprising:
a display that displays information related to operation of the washing machine; and
a driving source that drives the washing machine, wherein the first controller controls the display, and the second controller controls the driving source.

11. The washing machine of claim 1, wherein the external device comprises:
an external storage device that stores the upload operational data; and
an external controller that extracts the upload operational data from the external storage device or stores the upload operational data in the external storage device.

12. The washing machine of claim 11, wherein the external device has a grounding section independent from the washing machine.

13. The washing machine of claim 11, wherein the external controller is electrically connected to the controller, and the external controller transmits at least part of the upload operational data to the controller.

14. The washing machine of claim 13, wherein the controller stores the upload operational data transmitted from the external controller in the internal storage device.

15. The washing machine of claim 11, wherein the external device comprises one of a PDA, a laptop, or a mobile phone.

16. The washing machine of claim 1, wherein the internal storage device is provided in the controller.

17. The washing machine of claim 1, further comprising a display that displays information related to operation of the washing machine, wherein the replacing of the operational data with the upload operational data is displayed on the display.

18. The washing machine of claim 17, wherein the upload operational data is stored in the internal storage device and replaces the operational data, and the storing of the upload operational data is displayed on the display.

19. The washing machine of claim 17, wherein the display comprises a display device, and the display device displays at least one of a ratio at which the upload operational data is stored and a time taken to store all of the upload operational data.

20. The washing machine of claim 1, further comprising an input device, wherein, when an upload command is input from the input device, an electric signal is applied to the controller to replace the operational data with the upload operational data.

21. The washing machine of claim 20, wherein the input device comprises one of a button, a touch screen, or a voice recognizer.

22. The washing machine of claim 20, wherein, when a predetermined command is input by the input device while the external device is electrically connected to the controller, the controller detects at least part of the upload operational data from the external device and controls electric signals in accordance with the detected upload operational data, so that the washing machine is driven in accordance with the upload operational data.

23. The washing machine of claim 22, wherein, when an upload command is input into the input device, the controller transmits at least part of upload operational data from the external device and stores the upload operational data in the internal storage device.

24. The washing machine of claim 22, wherein the controller further comprises a first controller and a second controller, and when an upload command is input into the input device, the first controller transmits at least part of the upload operational data to the second controller and the second controller stores the upload operational data in the internal storage device.

25. The washing machine of claim 1, wherein the upload operational data is transmitted from an external web server storing upload operational data and stored in the external device.

26. The washing machine of claim 1, wherein, if the replacement of the upload operational data fails, the controller stops the replacement of the upload operational data and restores the operational data.

27. The washing machine of claim 1, wherein the external device communicates with the controller via one of a USB port, a cable, or a Wireless LAN.

28. The washing machine of claim 1, further comprising a slot provided in a main body of the washing machine configured to receive the external device.

29. The washing machine of claim 28, further comprising an input device within the slot.

30. An external device configured to communicate with a washing machine having a controller and an internal storage device that stores operational data of the controller, such that the external device communicates with the controller, wherein the external device stores upload operational data, the upload operational data being distinguished from the operational data, and replaces the operational data with the upload operational data.

31. The external device of claim 30, wherein the external device is configured to be electrically connected to the controller.

32. The external device of claim 30, wherein the storage device comprises one of a flash memory type storage device, a magnetic storage device, or an optical storage device.

33. A method of updating operational data of a washing machine, the method comprising:
loading upload operational data on an external device; and
providing communication between the external device and a controller of the washing machine to replace the operational data of the washing machine with the upload operational data, wherein the controller controls operations of the washing machine based on the upload operational data.

34. The method of claim 33, wherein providing communication between the external device and the controller of the washing machine comprises electrically connecting the external device and the controller of the washing machine.

35. The method of claim 33, wherein the controller reads the upload operational data stored on the external device to control the operations of the washing machine.

36. The method of claim 33, wherein the controller reads the upload operational data stored on the external device and stores the upload operational data in an internal storage device of the washing machine, and wherein the controller reads the upload operational data stored in the internal storage device to control the operations of the washing machine.

37. The method of claim 33, further comprising stopping replacement of the upload operational data, if the replacement operation fails, and restoring the operational data.

38. The method of claim 34, wherein the controller comprises a first controller and a second controller, and wherein the first controller is electrically connected to the external device and detects at least part of the upload operational data stored in the external device and transmits the detected at least part of the upload operational data to the second controller.

39. The method of claim 38, wherein the second controller stores the upload operational data transmitted from the first controller in an internal storage device of the washing machine.

40. The method of claim 33, wherein loading upload operational data on the external device comprises loading upload operational data on the external device from an external web server.
